(19) United States
(12) Patent Application Publication
(10) Pub. No.: US 2018/0260845 A1
(43) Pub. Date: Sep. 13, 2018

(54) Method for Direct Customized Advertising

(71) Applicants: Vaughn Peterson, Provo, UT (US); Jacob Christensen, Syracuse, UT (US); Steven Malone, Manti, UT (US); Robert Wesson, Riverton, UT (US)

(72) Inventors: Vaughn Peterson, Provo, UT (US); Jacob Christensen, Syracuse, UT (US); Steven Malone, Manti, UT (US); Robert Wesson, Riverton, UT (US)

(21) Appl. No.: 15/452,170

(22) Filed: Mar. 7, 2017

(51) Int. Cl. G06Q 30/02

(52) U.S. Cl. CPC G06Q 30/0255; G06Q 30/0261

(57) ABSTRACT

A method of direct customized advertising includes detecting an identity of a customer proximate to a brick-and-mortar store, obtaining historical shopping records associated with the customer, generating and printing customized coupons or advertisements based on the historical shopping records of the customer, and delivering the customized coupons or advertisements to the customer as they enter the brick-and-mortar store.

### BACKGROUND

### Field of the Invention

The present invention relates to a method for direct customized advertising to customers in a brick-and-mortar store.

### Background of the Invention

Brick-and-mortar stores discard millions of dollars in expired or unsold product each year. Retailers and manufactures supplying brick-and-mortar stores are willing to give substantial discounts on products that are expiring which need to be sold in a short amount of time. A need exists in matching specific historical shopping data of customers with time sensitive product sales at brick-and-mortar stores. The invention disclosed herein address such needs.

### SUMMARY

A method of direct customized advertising includes detecting an identity of a customer proximate to a brick-and-mortar store, obtaining historical shopping records associated with the customer, generating and printing customized coupons or advertisements based on the historical shopping records of the customer, and delivering the customized coupons or advertisements to the customer as they enter the brick-and-mortar store.

Printed customized coupons or advertisements may include a picture of the customer which was taken on the same day that the customized coupons or advertisements were delivered to the customer. The picture of the customer may be taken at a time between when the customer exited their car and when the customer entered the brick-and-mortar store. A door greeter of the brick-and-mortar store may deliver the customized coupons or advertisements to the customer. A product manufacture representative may deliver the customized coupons or advertisements to the customer. An online retailer representative may deliver the customized coupons or advertisements to the customer. The customized coupons or advertisements may be for products that have a product expiration date within a week of the print date of the customized coupons or advertisements. The customized coupons or advertisements may be for competing products of products of the historical shopping records associated with the customer. The customized coupons or advertisements may be for products overstocked in the brick-and-mortar store. The customized coupons or advertisements may be for products that are complimentary to recent online purchases by the customer. The customized coupons or advertisements may only be able to be used on the same date delivered to the customer or have an expiration date on the same day they were printed. The identity of the customer may be determined based on facial recognition. The identity of the customer may be determined based on a wireless signal. The identity of the customer may be determined based on optical character recognition of the license plates on the customer's vehicle. The identity of the customer may be determined based on a mobile phone signal of the customer. Point-of-sale purchases resulting from the customized coupons or advertisements may be tracked and associated with the customer historical shopping records. Customer historical shopping records may include one or more of Internet purchases, purchases associated with an address of the customer, purchases associated with a phone number of the customer, purchases associated with an email address of the customer, purchases associated with an account of the customer, or a combination thereof. Tracked point-of-sale purchase results may be used in a decision process when generating the customized coupons or advertisements. Tracked point-of-sale purchase results may be used in-part to determine a discount applied to a specific product item of the customized coupons or advertisements. The tracked point-of-sale purchase results may be used in-part to determine a specific product item offered in the customized coupons or advertisements.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a flow diagram in accordance with an embodiment of the invention;

FIG. 2 shows a perspective drawing in accordance with an embodiment of the invention;

FIG. 3 shows a perspective drawing in accordance with an embodiment of the invention;

FIG. 4 shows a perspective drawing in accordance with an embodiment of the invention;

FIG. 5 shows a perspective drawing in accordance with an embodiment of the invention;

FIG. 6 shows a flow diagram in accordance with an embodiment of the invention;

FIG. 7 shows a flow diagram in accordance with an embodiment of the invention;

FIG. 8 shows a flow diagram in accordance with an embodiment of the invention;

FIG. 9 shows a flow diagram in accordance with an embodiment of the invention; and

FIG. 10 shows a flow diagram in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings.

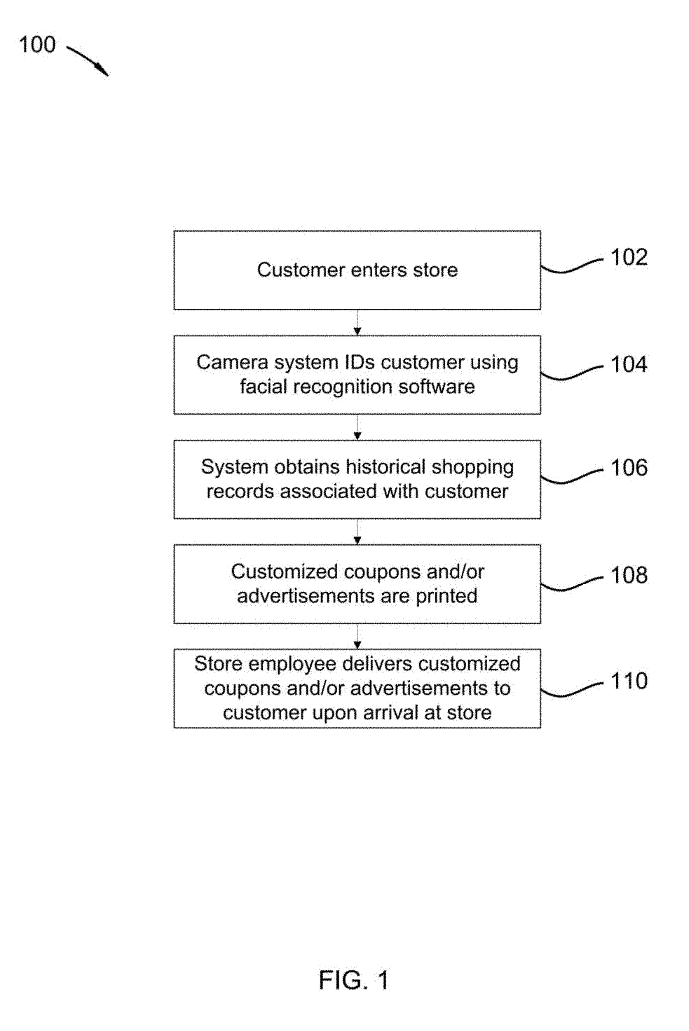

FIG. 1 is a flow diagram in accordance with an embodiment of the invention. Flow diagram 100 demonstrates a method of direct advertising by optically identifying and/or detecting an identity of a customer. A customer image capture and/or identity may be obtained by using optical, wireless, and/or Internet/intranet communications or social media interactions that indicate a proximity or an intent to be near a brick-and-mortar store 102. Electro-magnetic recognition 104 of a customer may include facial recognition technology, license plate character recognition by any image capturing device on store premises, Radio Frequency Identification Device (RFID), cellular signals or blue tooth signals generated from a device or device application. Historical shopping records 106 associated with the customer or potential customer may include digital shipping records, online shopping records, social media shopping records, stored database shopping records, social media records. A generated and printed 108 or transmitted customized coupons, sales, discounts, overstocked items and/or products, and advertising of competing and non-competing products of items defined in the historical shopping records and/or near-term and/or near-expiration perishable goods are then presented to the customer by a store employee, greeter or transmitted to a device (110). Customized coupons or advertisements may be specifically printed for products that have a short expiration period remaining.

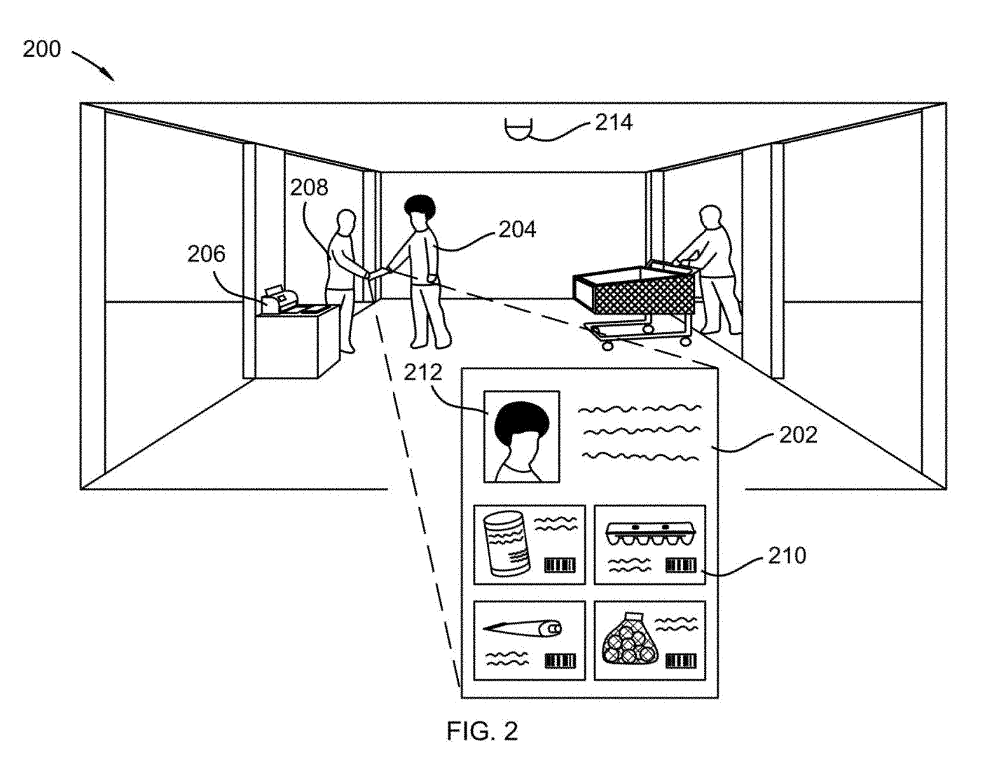

FIG. 2 is a perspective drawing in accordance with an embodiment of the invention depicting a brick and mortar store 200 entrance wherein the customer's image is captured electro-magnetically 214 and a printed photo 212 along with customized discount coupons, manufacturer rebates, advertisements, sales, 210 identification information and/or a personalized message and/or details of use, expiration 202 indication physical location and/or map of product(s)/item(s) 206 is then given to the customer by a store employee, greeter 208. For example, a customer 204 arrives at a Walmart parking lot and is recognized by a parking lot camera, an entry way camera 214, and/or a wireless signal from a customer vehicle or cell phone. Historical shopping records are obtained including online shopping, social media posts of products, and Walmart historical shopping records to determine customized advertising content 210. A picture of the customer 212 may be printed on the custom advertising sheet 202 enabling a Walmart greeter 208 to identify the customer 204 and give the customized advertising sheet 202 to the customer as the customer enters the store. Customized advertising sheet 202 may include a customized greeting relating to a recent social network posting of the customer. For example, happy birthday, happy anniversary, or any related inspirational quote liked or posted by the customer. Customized advertising content 210 may include coupons, discounts, rewards, and/or gift certificates. Customized advertising content 210 may be generated based on historical shopping records in connection with time sensitive store items. For example, Walmart may be overstocked with a particular brand of milk with a shortened life expectancy and a customer is predicted to purchase milk in the near future. In this case, a coupon for the specific overstocked milk product may be produced to encourage the customer to purchase a specific brand. Customized advertising sheet 202 may be printed and given to the customer without any waiting time as the customer arrives at the store.

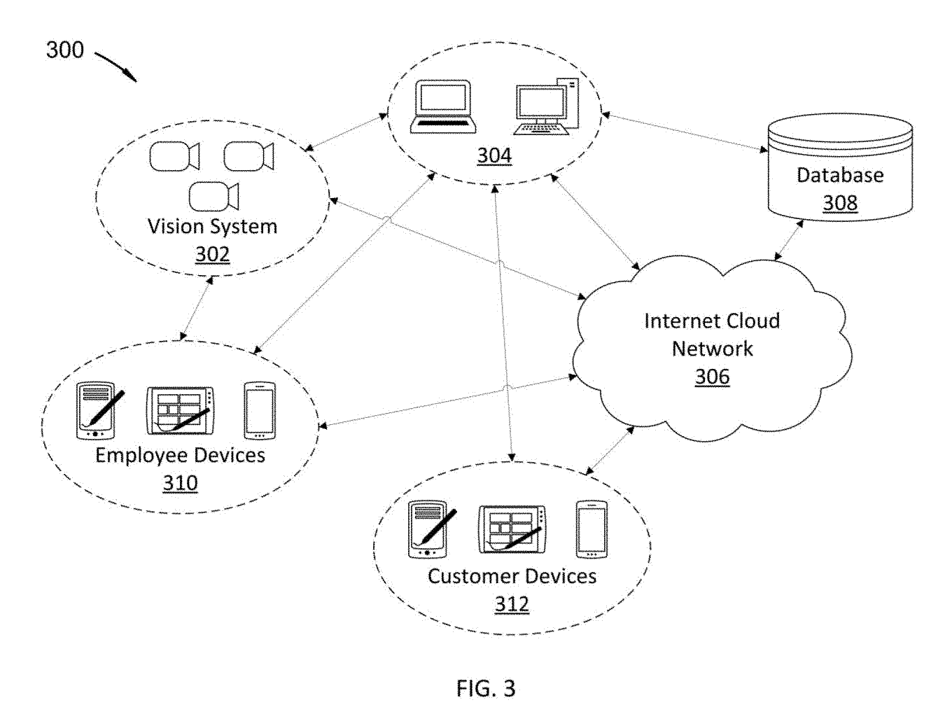

FIG. 3 shows a diagram depicting devices and methods of customized advertising to customers in accordance with an embodiment of the invention. System 300 may include machine vision system 302, one or more computers or processors 304, a cloud based wide area network 306, databases 308 including database servers, customer devices 312, and employee printer devices 310 which all may communicate wirelessly and/or by wire. Machine vision system 302 may include one or more cameras used to detect customers around or proximate to a brick-and-mortar store. The machine vision may use defined facial features of a customer to determine a customer identity, such as known facial recognition software. One or more cameras may be used within or without a store to obtain identification of customers entering the store. Machine vision may also identify customers by detecting vehicle license plate lettering, or dimensional constraints of physical features of customers. Vehicle license plates may be added to a customer profile and used to identify a customer or customer household. One or more computers 302 may be connected wirelessly or by wire to each camera of vision system 302. Computers 304 may provide processing and data storage allowing tracking and identification of customers. Computers 304 may form a local area network within a company with multiple locations with a shared database. Wide area network 306 may include the Internet, cloud based servers and databases, which may be local or remote from a store using vision system 302. Computers 304 may transmit and receive data over a local area network and/or a wide area network. Digital image processing, identification, and tracking may be performed on a cloud based server or on local computers. An electronic image of the customer may be taken by the machine vision system 302/304 arriving at a store. The image obtained be transmitted to a computer 304 or a network system where the image is superimposed with customized advertising. The image of the customer may include a portion of the clothing the customer is wearing allowing a door greeter to easily match a customized advertisement with a customer. A customer picture may be in black and white when printed on the customized advertising sheet and any clothing captured in the image may allow easier matching. Database 308 may be a store database and/or a remote purchase history database with compiled online purchase histories of customers. A customer profile may be kept in database 308 and accessed as advertisements are generated.

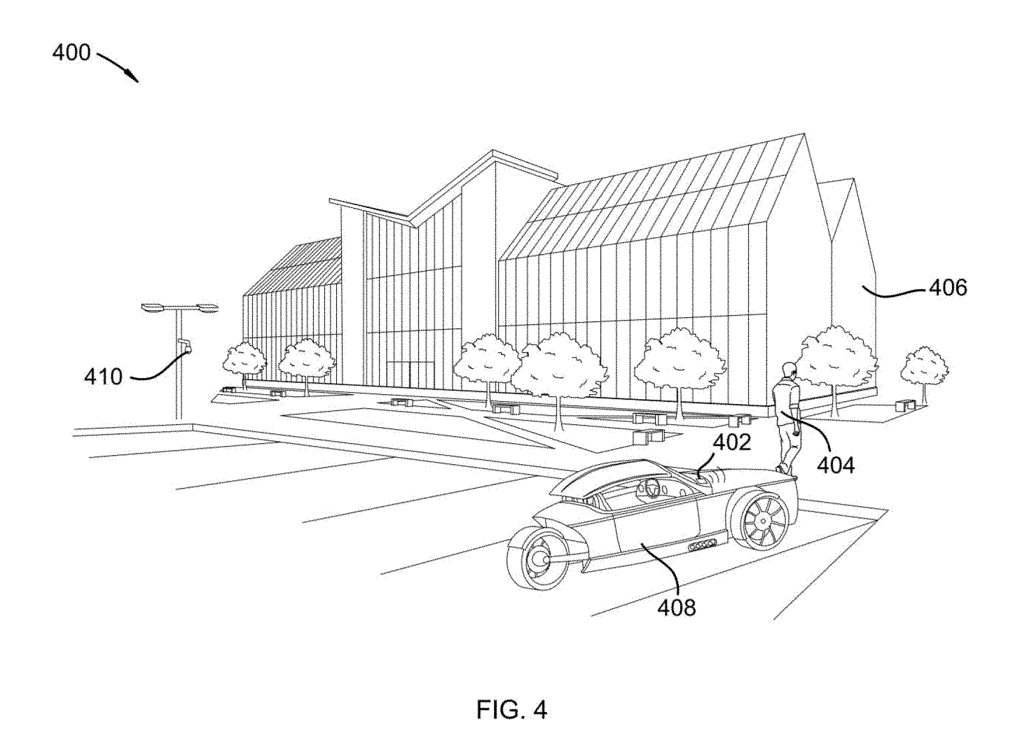

FIG. 4 shows a perspective drawing 400 in accordance with an embodiment of the invention showing a brick-and-mortar store 406 with one or more parking lot cameras 410. An automobile 408 and/or a customer 404 may posess Bluetooth devices 402, Wi-Fi Internet enabled GPS devices 402, wireless devices, RFID devices 402, capable of transmitting and receiving customer identification information. Other devices may include mobile phones, IPads, laptops, key fobs, key chain transceivers, RFID credit card devices, and watches. A picture of the customer 404 may be taken at a time between when the customer exited their car 408 and when the customer entered the brick-and-mortar store 406. Camera 410 may obtain an image of customer 404 and sent the customer image to a custom generated advertisement and combine the image with the custom generated advertisement. The custom advertisement may then be printed out and handed to the customer as he/she walks into brick-and-mortar store 406.

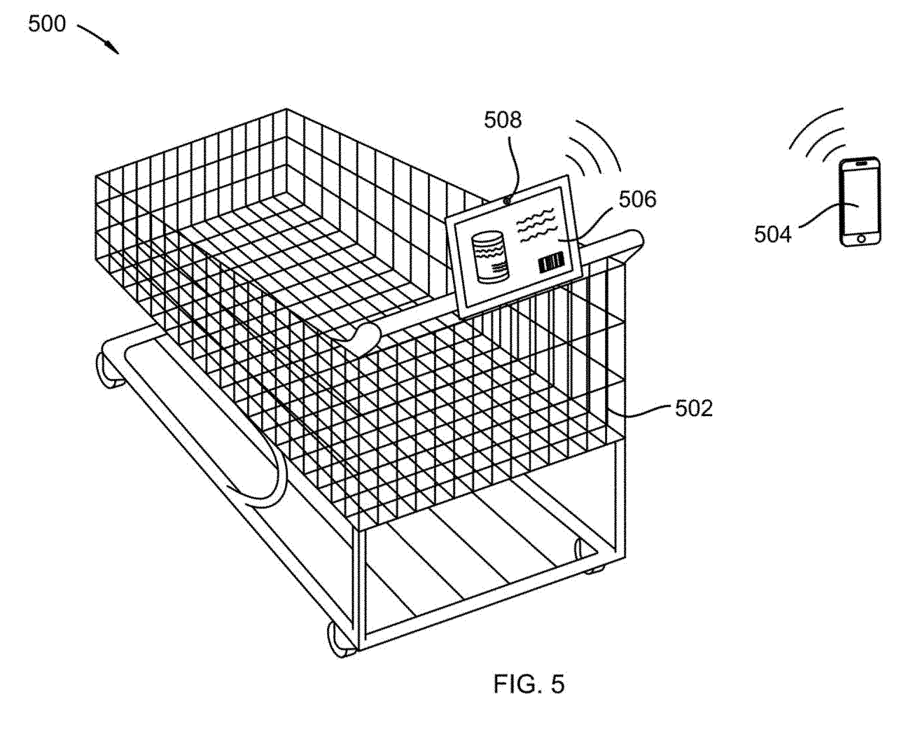

FIG. 5 is a perspective drawing in accordance with an embodiment of the invention. A door greeter, employee and/or representative of a brick and mortar store and/or a product manufacturer presents a customer with a transport mechanism 500,502 or product container wherein is attached a customer device 506. Customer device 506 may be used to display any one of or any combinations of digital version of customized coupons, sales or discounts. Customer device 506 may be automatically associated with a customer as a customer takes a shopping cart 502 by means of camera 508. Camera 508 may identify or match an image of the customer with a previously taken picture to associate the customer device with customized advertising. Near-term and/or near-expiration perishable goods and/or product advertising and/or customer survey/feedback/scorecard, itemized shopping list based on past shopping records, or similar products may be displayed for a customer on display 506.

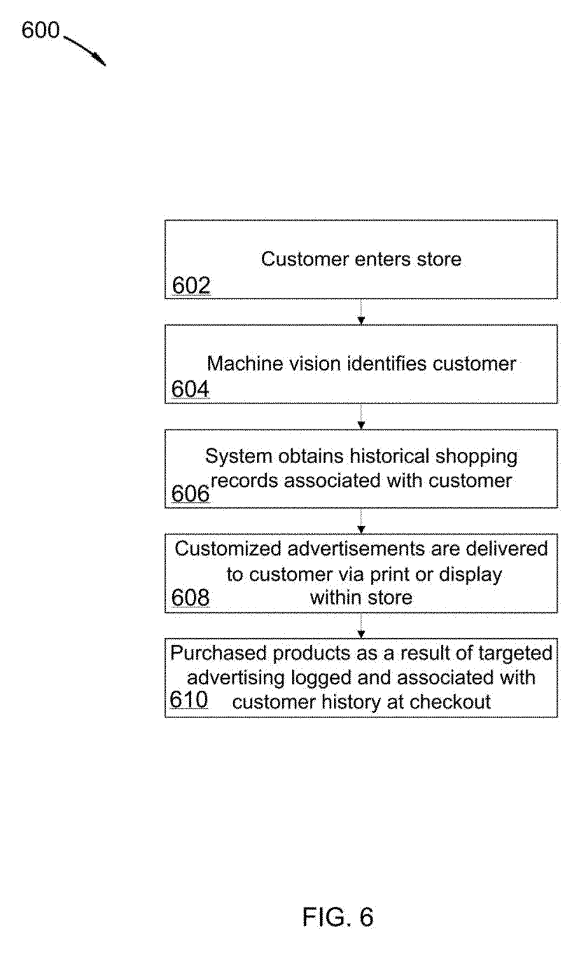

FIG. 6 is a flow diagram 600 in accordance with an embodiment of the invention. As a customer enters a store or is proximate to a store entrance or is in route to a store 602, machine vision 604 takes a picture of the customer and the customer is then identified by facial recognition or image matching with a previously stored customer profile or an online profile. The identified customer's historical shopping records are obtained and may be associated with potential purchases and/or overstocked items in the store. Historical shopping records 606 may be associated with a customer and may be utilized to create customize advertisements, coupons, rebates and sales and may be delivered to the customer via printed material or display by display devices 608. Purchased products as a result of targeted advertising may be recorded and associated with the customer history at time of checkout 610. Manufactures may provide commissions for offering discounts to targeted customers based on a past shopping history. A confirmed discount may be recorded and saved at the point-of-sale.

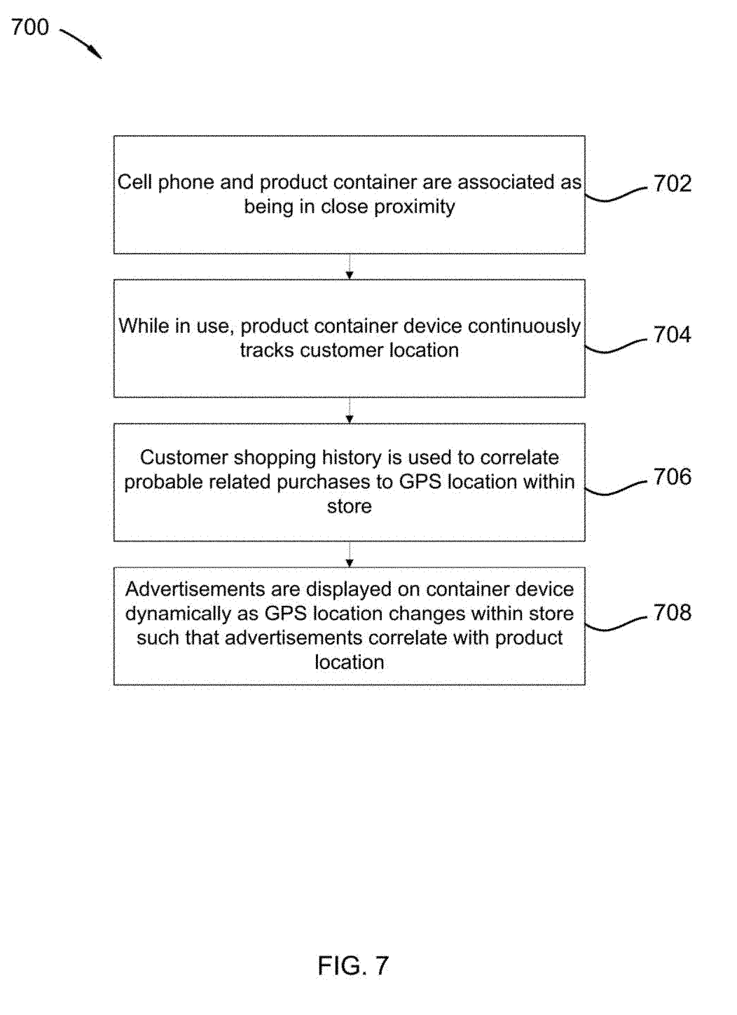

FIG. 7 is a flow diagram 700 in accordance with an embodiment of the invention. A customer's location may be determined to be proximate to a store when an Internet based cell phone application determines a current location of a customer and determines the customer is in route to or in a customer parking lot. Additionally, or alternately, a Wi-Fi, Bluetooth, or carrier signal of a customer's electronic device may indicate that a customer is proximate to a store location 702. A product container device, such as a tablet or phone attached to a product container, may track a continuous customer location 706 and display customized advertisements dynamically based on the continuously tracked location of the customer while the customer is in the store 708.

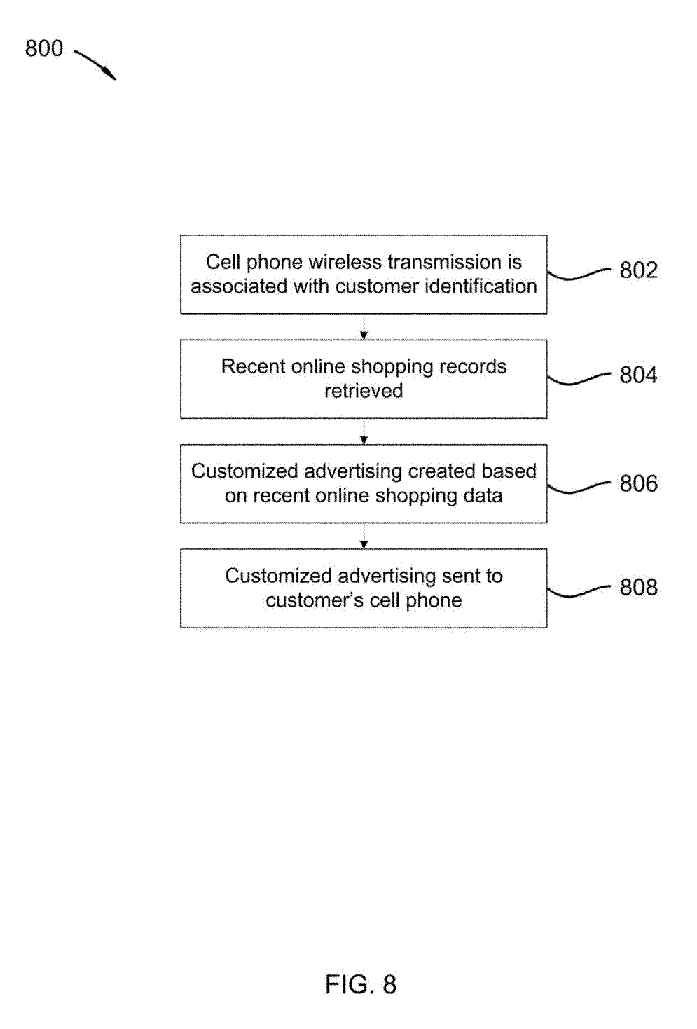

FIG. 8 is a flow diagram (800) in accordance with an embodiment of the invention. A customer's location and identification 802 may be determined to be proximate to a store when an Internet based cell phone application determines a current location of a customer and determines the customer is in route to or in a customer parking lot. Additionally, or alternately, a Wi-Fi, Bluetooth, or carrier signal of a customer's electronic device may indicate a customer identification and that a customer is proximate to a store location 802. A customer's cell phone may track a continuous customer location within a store and receive customized advertisements dynamically based on the continuously tracked location of the customer while the customer is in the store 708. Additionally, or alternatively, historical shopping records 804 and/or current location within store may be used to generate customized advertising 806 then sent to a customer's wireless device (808).

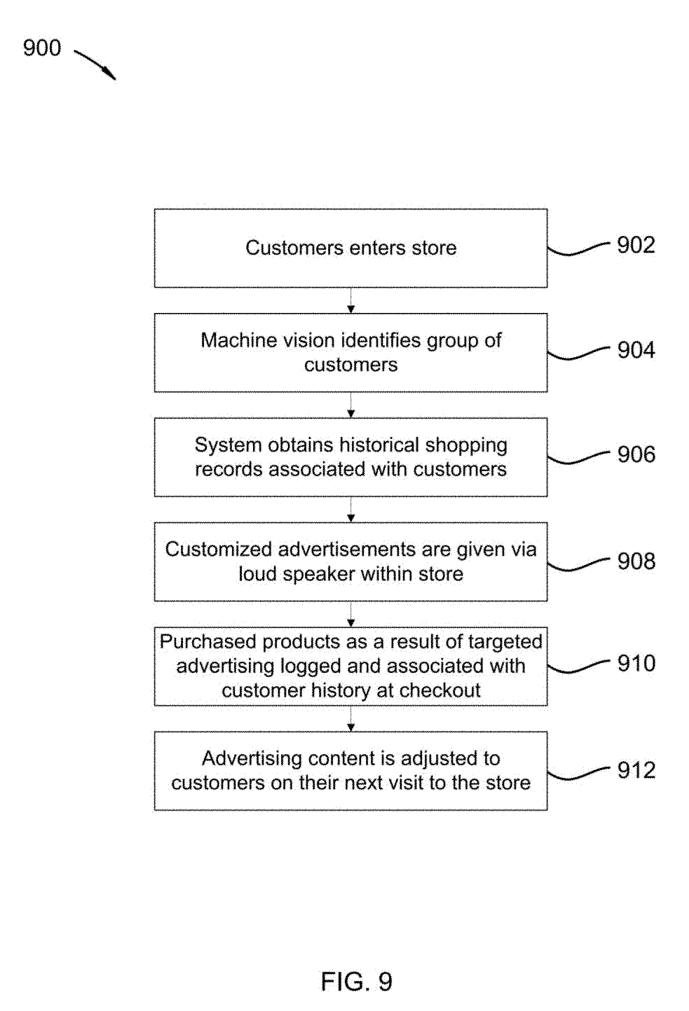

FIG. 9 is a flow diagram 900 in accordance with an embodiment of the invention. A group of customers are shopping within a brick-and-mortar store 902. One or more cameras of a vision system identify two or more customers of the group 904. Historical shopping records may be obtained based on a positive identification of two or more customers of the group 906. Customized advertisements may be generated based on populations within the group and loud speaker (verbal) advertisements may be given based on historical records of the group 908. Products purchased as a result of the verbal advertisements may be recorded and associated with a customer history and group history 910. Future advertising content may be determined based on results previous purchase history vocal advertising data 912. Customize advertisements and sales event may be communicated by a storewide public address system 908. Product purchases independent of and resulting from and targeted advertisement may be added to customer purchase history at checkout 910 and advertising content may be adjusted to the updated customer profile for a customer's next visit to the store 912.

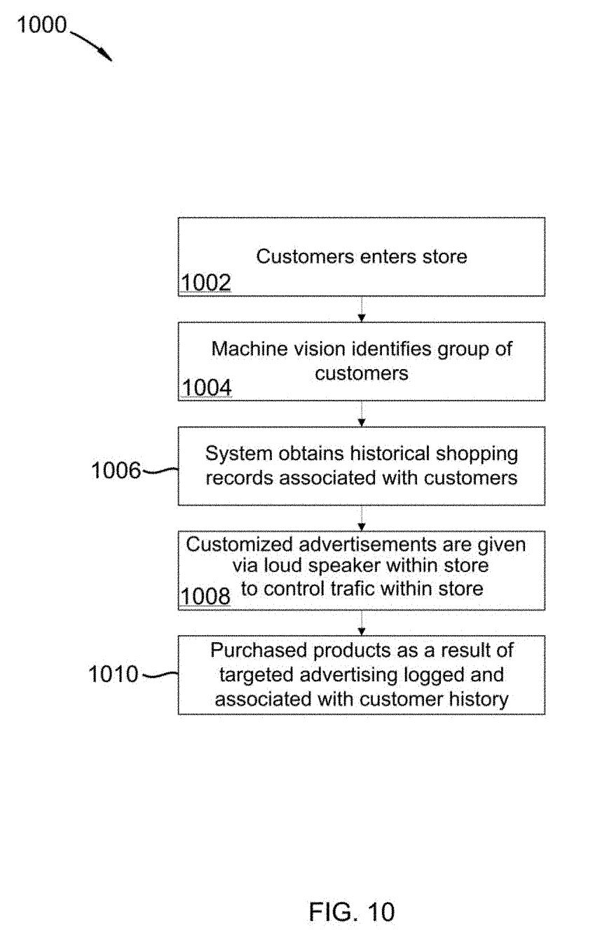

FIG. 10 is a flow diagram 1000 in accordance with an embodiment of the invention. A group of customers are shopping within a brick-and-mortar store 1002. One or more cameras of a vision system identify two or more customers of the group 1004. Historical shopping records may be obtained based on a positive identification of two or more customers of the group 1006. Customized advertisements may be generated based on populations within the group and loud speaker (verbal) advertisements may be given based on historical records of the group 1006. Customized advertisements may be given based on a number of customers in a given area of a store or to control traffic congestion within a store 1008. For instance, if one area of a store is getting crowded or unsafe, a determination may be made based on historical or current shopping items that a donut sale would clear the congested area. An announcement may advertise, over a loud speaker, that donuts are on sale 50% off for the next 5 mins. Products purchased as a result of the verbal advertisements may be recorded and associated with a customer history and group history 1010. Future advertising content may be determined based on results previous purchase history vocal advertising data. Customize advertisements and sales event may be communicated by a storewide public address system. Product purchases independent of and resulting from and targeted advertisement may be added to customer purchase history and confirmed at checkout and advertising content may be adjusted to the updated customer profile for a customer's next visit to the store.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of direct customized advertising comprising:
detecting an identity of a customer proximate to a brick-and-mortar store;
obtaining historical shopping records associated with the customer;
generating and printing customized coupons or advertisements based on the historical shopping records of the customer; and
delivering the customized coupons or advertisements to the customer as they enter the brick-and-mortar store.

2. The method of claim 1, wherein the printed customized coupons or advertisements include a picture of the customer.

3. The method of claim 2, wherein the picture of the customer was taken at a time between when the customer exited their car and when the customer entered the brick-and-mortar store.

4. The method of claim 3, wherein a door greeter of the brick-and-mortar store delivers the customized coupons or advertisements to the customer.

5. The method of claim 3, wherein a product manufacture representative delivers the customized coupons or advertisements to the customer.

6. The method of claim 1, wherein an online retailer representative delivers the customized coupons or advertisements to the customer.

7. The method of claim 1, wherein the customized coupons or advertisements are for products that have a short expiration period remaining.

8. The method of claim 1, wherein the customized coupons or advertisements are for competing products of products of the historical shopping records associated with the customer.

9. The method of claim 1, wherein the customized coupons or advertisements are for products overstocked in the brick-and-mortar store.

10. The method of claim 1, wherein the customized coupons or advertisements are for products that are complimentary to recent online purchases by the customer.

11. The method of claim 1, wherein the customized coupons or advertisements are only able to be used on the same date delivered to the customer.

12. The method of claim 1, wherein the identity of the customer is determined based on facial recognition.

13. The method of claim 1, wherein the identity of the customer is determined based on a wireless signal.

14. The method of claim 1, wherein the identity of the customer is determined based on optical character recognition of the license plates on the customer's vehicle.

15. The method of claim 1, wherein the identity of the customer is determined based on a mobile phone signal of the customer.

16. The method of claim 1, further comprising tracking point-of-sale purchases resulting from the customized coupons or advertisements and associating the point-of-sale purchase results with the customer historical shopping records.

17. The method of claim 1, wherein customer historical shopping records include one or more of Internet purchases, purchases associated with an address of the customer, purchases associated with a phone number of the customer, purchases associated with an email address of the customer, purchases associated with an account of the customer, or a combination thereof.

18. The method of claim 16, wherein the tracked point-of-sale purchase results are used in a decision process when generating the customized coupons or advertisements.

19. The method of claim 16, wherein the tracked point-of-sale purchase results are used in part to determine a discount applied to a specific product item of the customized coupons or advertisements.

20. The method of claim 16, wherein the tracked point-of-sale purchase results are used in part to determine a specific product item offered in the customized coupons or advertisements.
